(19) United States
(12) Patent Application Publication
(10) Pub. No.: US 2026/0040034 A1
(43) Pub. Date: Feb. 5, 2026

(54) SIDELINK POSITIONING REFERENCE SIGNAL PROCESSING METHOD AND APPARATUS, TERMINAL, AND STORAGE MEDIUM

(71) Applicant: VIVO MOBILE COMMUNICATION CO., LTD., Guangdong (CN)

(72) Inventor: Zhanyuan WANG, Dongguan (CN)

(73) Assignee: VIVO MOBILE COMMUNICATION CO., LTD., Guangdong (CN)

(21) Appl. No.: 19/358,094

(22) Filed: Oct. 14, 2025

Related U.S. Application Data
(63) Continuation of application No. PCT/CN2024/087051, filed on Apr. 10, 2024.

(30) Foreign Application Priority Data
Apr. 14, 2023 (CN) 202310405245.1

(51) Int. Cl. H04W 4/029; H04L 5/00; H04W 8/24; H04W 56/00

(52) U.S. Cl. CPC H04W 4/029; H04L 5/0051; H04W 8/24; H04W 56/001

(57) ABSTRACT

This application discloses a sidelink positioning reference signal processing method and apparatus, a terminal, and a storage medium, pertaining to the field of communication technology. A sidelink positioning reference signal processing method according to an embodiment of this application includes the following steps: performing, by a first terminal, a first behavior based on configuration information during selection or reselection of a target synchronization source; where the first behavior includes one of the following behaviors: normally transmitting or normally receiving a sidelink positioning reference signal; and dropping transmission or reception of the sidelink positioning reference signal; and the configuration information is used to configure priorities of multiple synchronization sources.

### CROSS-REFERENCE TO RELATED APPLICATIONS

This application is a continuation application of International Application No. PCT/CN2024/087051, filed on Apr. 10, 2024, which claims priority to Chinese Patent Application No. 202310405245.1, filed on Apr. 14, 2023 and entitled “SIDELINK POSITIONING REFERENCE SIGNAL PROCESSING METHOD AND APPARATUS, TERMINAL, AND STORAGE MEDIUM”, which is incorporated herein by reference in its entirety.

### TECHNICAL FIELD

This application pertains to the field of communication technology, and specifically relates to a sidelink positioning reference signal processing method and apparatus, a terminal, and a storage medium.

### BACKGROUND

A new radio (NR) system supports sidelink (SL) transmission such as unicast, multicast, or groupcast.

In a sidelink system, terminals (User Equipment, UE) can directly transmit data at the physical layer without using a network-side device. A prerequisite for sidelink communication is that all devices participating in sidelink communication in a region are synchronized. Therefore, sidelink positioning needs to be based on a corresponding synchronization source. Additionally, a protocol introduces a sidelink positioning reference signal (Sidelink-Positioning Reference Signal, SL-PRS) for sidelink positioning.

### SUMMARY

Embodiments of this application provide a sidelink positioning reference signal processing method and apparatus, a terminal, and a storage medium.

According to a first aspect, a sidelink positioning reference signal processing method is provided, executed by a terminal. The method includes:
performing, by a first terminal, a first behavior based on configuration information during selection or reselection of a target synchronization source; where
the first behavior includes one of the following behaviors:
normally transmitting or normally receiving a sidelink positioning reference signal; and
dropping transmission or reception of the sidelink positioning reference signal; and
the configuration information is used to configure priorities of multiple synchronization sources.

According to a second aspect, a sidelink positioning reference signal processing method is provided, executed by a terminal. The method includes:
determining, by a first terminal, a target measurement period based on whether there is dropping of a sidelink positioning reference signal or not; and
performing, by the first terminal, measurement on the sidelink positioning reference signal based on the target measurement period; where
the target measurement period is at least related to the following time:
a measurement time of a first number of sidelink positioning reference signal samples required to obtain one valid measurement result.

According to a third aspect, a sidelink positioning reference signal processing method is provided, executed by a terminal. The method includes:
performing, by a first terminal during measurement of a sidelink positioning reference signal, a second behavior if switching to a target synchronization source is performed; where
the second behavior includes one of the following behaviors:
continuing with the measurement of the sidelink positioning reference signal; and
discarding the current measurement of the sidelink positioning reference signal.

According to a fourth aspect, a sidelink positioning reference signal processing apparatus is provided, including:
a first execution module configured to perform a first behavior based on configuration information during selection or reselection of a target synchronization source; where
the first behavior includes one of the following behaviors:
normally transmitting or normally receiving a sidelink positioning reference signal; and
dropping transmission or reception of the sidelink positioning reference signal; and
the configuration information is used to configure priorities of multiple synchronization sources.

According to a fifth aspect, a sidelink positioning reference signal processing apparatus is provided, including:
a determining module configured to determine a target measurement period based on whether there is dropping of a sidelink positioning reference signal or not; and
a measurement module configured to perform measurement on the sidelink positioning reference signal based on the target measurement period; where
the target measurement period is at least related to the following time:
a measurement time of a first number of sidelink positioning reference signal samples required to obtain one valid measurement result.

According to a sixth aspect, a sidelink positioning reference signal processing apparatus is provided, including:
a second execution module configured to perform a second behavior if switching to a target synchronization source is performed during measurement of a sidelink positioning reference signal; where
the second behavior includes one of the following behaviors:
continuing with the measurement of the sidelink positioning reference signal; and
discarding the current measurement of the sidelink positioning reference signal.

According to a seventh aspect, a terminal is provided. The terminal includes a processor and a memory, where the memory stores a program or instructions capable of running on the processor, and when the program or instructions are executed by the processor, the steps of the method according to the first aspect are implemented, or the steps of the method according to the second aspect are implemented, or the steps of the method according to the third aspect are implemented.

According to an eighth aspect, a terminal is provided, including a processor and a communication interface, where the processor is configured to execute a program or instructions to implement the steps of the method according to the first aspect, or implement the steps of the method according to the second aspect, or implement the steps of the method according to the third aspect, and the communication interface is coupled to the processor.

According to a ninth aspect, a readable storage medium is provided. The readable storage medium stores a program or instructions, and when the program or instructions are executed by a processor, the steps of the method according to the first aspect are implemented, or the steps of the method according to the second aspect are implemented, or the steps of the method according to the third aspect are implemented.

According to a tenth aspect, a wireless communication system is provided, including: a first terminal and a second terminal performing sidelink communication with the first terminal, where the first terminal is configured to perform the steps of the method according to the first aspect, or implement the steps of the method according to the second aspect, or implement the steps of the method according to the third aspect.

According to an eleventh aspect, a chip is provided. The chip includes a processor and a communication interface, the communication interface is coupled to the processor, and the processor is configured to execute a program or instructions to implement the steps of the method according to the first aspect, or implement the steps of the method according to the second aspect, or implement the steps of the method according to the third aspect.

According to a twelfth aspect, a computer program/program product is provided. The computer program/program product is stored in a storage medium, and the computer program/program product is executed by at least one processor to implement the steps of the method according to the first aspect, or implement the steps of the method according to the second aspect, or implement the steps of the method according to the third aspect.

### BRIEF DESCRIPTION OF DRAWINGS

FIG. 1 is a block diagram of a wireless communication system to which an embodiment of this application is applicable;

FIG. 2 is a schematic diagram of a sidelink transmission scenario in the related art;

FIG. 3 is a schematic diagram of resource allocation in the related art;

FIG. 4 is another schematic diagram of resource allocation in the related art;

FIG. 5 is a flowchart of a sidelink positioning reference signal processing method according to an embodiment of this application;

FIG. 6 is a schematic diagram of sidelink communication according to an embodiment of this application;

FIG. 7 is a schematic diagram of synchronization source selection or reselection according to an embodiment of this application;

FIG. 8 is another schematic diagram of synchronization source selection or reselection according to an embodiment of this application;

FIG. 9 is a schematic diagram of a synchronization reference terminal synchronized with a synchronization source of a first terminal according to an embodiment of this application;

FIG. 10 is a schematic diagram of a synchronization reference terminal asynchronized with a synchronization source of a first terminal according to an embodiment of this application;

FIG. 11 is a schematic diagram illustrating that a sidelink positioning reference signal period is equal to a sidelink synchronization signal period according to an embodiment of this application;

FIG. 12 is a schematic diagram illustrating that a sidelink positioning reference signal period is less than a sidelink synchronization signal period according to an embodiment of this application;

FIG. 13 is a schematic diagram illustrating that a sidelink positioning reference signal period is greater than a sidelink synchronization signal period according to an embodiment of this application;

FIG. 14 is another schematic diagram of sidelink communication according to an embodiment of this application;

FIG. 15 is a flowchart of another sidelink positioning reference signal processing method according to an embodiment of this application;

FIG. 16 is a flowchart of another sidelink positioning reference signal processing method according to an embodiment of this application;

FIG. 17 is a schematic diagram of synchronization source switching according to an embodiment of this application;

FIG. 18 is a schematic structural diagram of the sidelink positioning reference signal processing apparatus corresponding to FIG. 5;

FIG. 19 is a schematic structural diagram of the sidelink positioning reference signal processing apparatus corresponding to FIG. 15;

FIG. 20 is a schematic structural diagram of the sidelink positioning reference signal processing apparatus corresponding to FIG. 16; and

FIG. 21 is a schematic structural diagram of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “or” in this application indicates at least one of the connected objects. For example, “A or B” covers three schemes, that is, scheme 1: including A and not including B; scheme 2: including B and not including A; and scheme 3: including both A and B. The character “/” generally indicates that the associated objects before and after it are in an “or” relationship.

The term “indication” in this application can be either a direct indication (or explicit indication) or an indirect indication (or implicit indication). Direct indication can be understood as the sender explicitly informing the receiver of content such as specific information, operations to be performed, or requested results in the sent indication. Indirect indication can be understood as the receiver determining corresponding information based on the indication sent by the sender, or making judgments and determining operations to be performed, requested results, or the like based on the judgment results.

It should be noted that technologies described in the embodiments of this application are not limited to a long term evolution (LTE) or LTE-advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (Single-carrier Frequency Division Multiple Access, SC-FDMA), and other systems. The terms “system” and “network” are often used interchangeably in the embodiments of this application. The technologies described may be used in the above-mentioned systems and radio technologies as well as other systems and radio technologies. In the following descriptions, a new radio system is described for an illustration purpose, and NR terms are used in most of the following descriptions, although these technologies may also be applied to other applications than an NR system application, for example, the 6th generation (6th Generation, 6G) communication system.

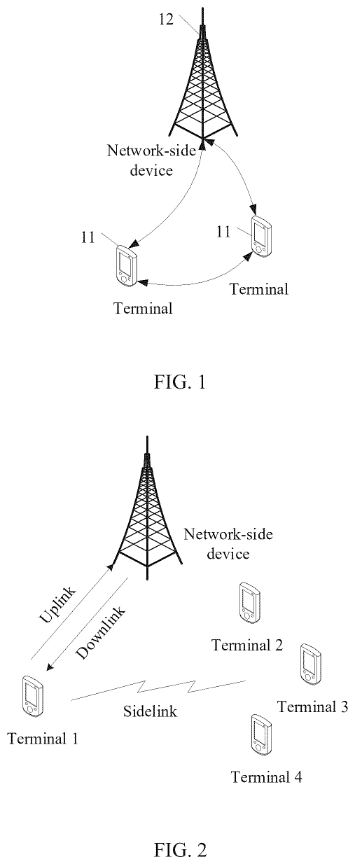

FIG. 1 is a block diagram of a wireless communication system to which an embodiment of this application is applicable. The wireless communication system includes a terminal 11 and a network-side device 12.

The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) or virtual reality (VR) device, a robot, a wearable device, a flight vehicle, vehicle user equipment (VUE), ship-borne equipment, pedestrian user equipment (PUE), smart household (home devices with wireless communication functions, such as refrigerators, televisions, washing machines, or furniture), a game console, a personal computer (PC), a teller machine, or a self-service machine. The wearable device includes a smartwatch, a smart band, smart earphones, smart glasses, smart jewelry (a smart bracelet, a smart hand chain, a smart ring, a smart necklace, a smart foot bangle, a smart anklet, and the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that the specific type of the terminal 11 is not limited in the embodiments of this application.

The network-side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (gNB), a new radio NodeB (NR Node B), an access point, a relay base station (RBS), a serving base station (SBS), a base transceiver station (BTS), a radio base station, a radio transceiver, a basic service set (BSS), an extended service set (ESS), a home NodeB (home Node B, HNB), a home evolved NodeB (home evolved Node B), a transmission reception point (TRP), or other appropriate terms in the art. Provided that the same technical effects are achieved, the base station is not limited to any specific technical term. It should be noted that in the embodiments of this application, only the base station in the NR system is used as an example, although the specific type of the base station is not limited.

How a terminal processes a sidelink positioning reference signal during synchronization source selection or reselection is currently unclear. Uncertainty in terminal behavior can affect smooth implementation of sidelink positioning, reducing the efficiency of sidelink communication.

Embodiments of this application provide a sidelink positioning reference signal processing method and apparatus, a terminal, and a storage medium, to clarify a sidelink positioning reference signal processing behavior of a terminal, thereby ensuring smooth sidelink positioning and improving sidelink communication efficiency.

For ease of understanding, the related technologies and concepts involved in the embodiments of this application are introduced below.

### I. About Sidelink

As shown in FIG. 2, terminal 1 can perform sidelink transmission with terminal 2, terminal 3, and terminal 4, such as transmitting/receiving/measuring a sidelink channel or signal. Also, terminal 1 can communicate with a network-side device through uplink and downlink.

A new radio sidelink includes the following channels:
physical sidelink control channel (PSCCH);
physical sidelink shared channel (PSSCH);
physical sidelink broadcast channel (PSBCH); and
physical sidelink feedback channel (PSFCH).

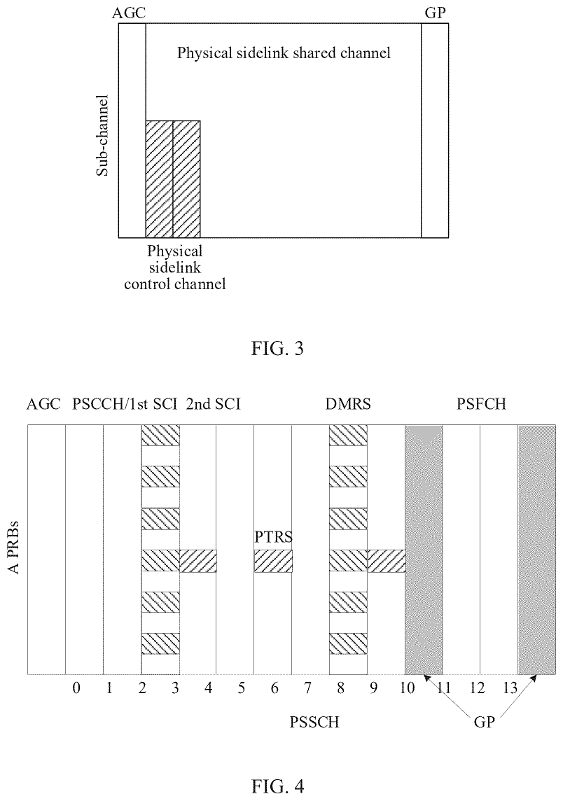

The physical sidelink shared channel allocates resources on sub-channel basis, using continuous resource allocation in frequency domain. The time-domain resource of the physical sidelink control channel is the number of symbols configured by the higher layer, and the frequency-domain size is a parameter configured by the higher layer. In addition, the frequency-domain resource of the physical sidelink control channel is limited to be less than or equal to the size of one sub-channel, and the physical sidelink control channel is within the range of the lowest sub-channel of the physical sidelink shared channel, as shown in FIG. 3, where AGC represents automatic gain control, and GP represents guard period.

In R16/R17 new radio sidelink, sidelink resources are allocated on slot basis. That is, the resource allocation is based on slots. In frequency domain, resources are allocated on sub-channel basis. Each sub-channel consists of A continuous physical resource blocks (PRB), as shown in FIG. 4. The value of A is a parameter configured by radio resource control (RRC). PTRS represents phase tracking reference signal, DMRS represents demodulation reference signal, 1st SCI represents first-stage sidelink control information (SCI), and 2nd SCI represents second-stage sidelink control information.

### II. About Sidelink Positioning

In NR positioning, downlink positioning reference signals and uplink positioning reference signals are introduced. The downlink positioning reference signal includes, for example, a Positioning Reference Signal (PRS), and the uplink positioning reference signal includes, for example, a sounding reference signal for positioning (SRS-Pos). Requirements are specified for terminal measurement behavior for each measurement quantity, measurement period, measurement accuracy for each measurement quantity, and the like. For example, in TS 38.133, for reference signal time difference (RSTD) measurement, requirements are specified for measurement periods based on and not based on measurement gaps. The measurement period is related to various factors such as the number of frequency layers, PRS measurement period on each frequency layer, receive beams, and the number of PRS samples.

The measurement quantities and reference signals included in the R16/R17 positioning methods are shown in Table 1 below.

TABLE 1

| | | Terminal-side | Network-side device |
|---|---|---|---|
| NR positioning | Reference | measurement | measurement |
| method | signal | quantity | quantity |
| DL-TDOA | DL PRS | DL PRS RSTD | / |
| DL-AOD | DL PRS | DL PRS | AoA/ZoA |
| | | RSRP/RSRPP | |
| UL-TDOA | UL SRS-Pos | / | UL SRS RTOA |
| UL-AOA | UL SRS-Pos | / | AoA/ZoA |
| E-CID | SSB/CSI-RS | UE Rx-Tx time | gNB Rx-Tx time |
| | | difference, | difference, |
| | | RSRP/RSRQ | AoA/ZoA |
| Multi-RTT | DL PRS/UL | UE Rx-Tx time | gNB Rx-Tx time |
| | SRS-Pos | difference | difference |

TDOA represents time difference of arrival, AOD represents angle of departure, AOA represents angle of arrival, E-CID represents enhanced cell-ID, Multi-RTT represents multi-round-trip time, SSB represents synchronization signal block, CSI-RS represents channel state information reference signal (Channel State Information-Reference Signal), RSRP represents reference signal received power, RSRPP represents reference signal received path power, Rx-Tx time difference represents receive-transmit time difference, RSRQ represents reference signal received quality, AoA represents azimuth angle of arrival (Azimuth of Arrival), ZoA represents zenith angle of arrival (Zenith of Arrival), and RTOA represents relative time of arrival.

In the sidelink system, requirements are also defined for the terminal measurement behavior and evaluation period for synchronization signals. In R17, sidelink discontinuous reception (SL-DRX) is introduced, which is a method to reduce terminal power consumption. A terminal with the sidelink discontinuous reception enabled receives data only during the sidelink discontinuous reception active period. A corresponding cycle is configured for the sidelink discontinuous reception.

In R18, sidelink positioning reference signal is introduced for sidelink positioning. 3GPP specifies sidelink-based positioning scenarios. Sidelink positioning may include the following positioning measurements:
sidelink positioning reference signal based receive-transmit time difference measurement (SL-PRS based Rx-Tx measurement);
sidelink positioning reference signal based reference signal time difference measurement (SL-PRS based RSTD measurement);
sidelink positioning reference signal based reference signal received power measurement (SL-PRS based RSRP measurement);
sidelink positioning reference signal based reference signal received path power measurement (SL-PRS based RSRPP measurement);
sidelink positioning reference signal based relative time of arrival measurement (SL-PRS based RTOA measurement);
sidelink positioning reference signal based azimuth angle of arrival measurement (SL-PRS based Azimuth of arrival measurement); and
sidelink positioning reference signal based zenith angle of arrival measurement (SL-PRS based Zenith of arrival measurement).

### III. About Sidelink Synchronization Source Selection or Reselection

A prerequisite for sidelink communication is that all devices participating in sidelink communication in a region are synchronized. Therefore, it is specified that sidelink positioning is performed based on a corresponding synchronization source. Four synchronization sources are defined for sidelink communication:
global navigation satellite system (GNSS);
gNB;
eNB; and
synchronization reference terminal (SyncRef UE).

Sidelink communication supports two synchronization methods: one is a synchronization method with GNSS as the highest-priority synchronization source, and the other is a synchronization method with eNB/gNB (serving cell/primary cell (PCell)) as the highest-priority synchronization source.

In the synchronization method with GNSS as the highest-priority synchronization source, the priority order is as follows:
P0: GNSS;
P1: terminal directly synchronized to GNSS (UE directly synchronized to GNSS);
P2: terminal indirectly synchronized to GNSS (UE indirectly synchronized to GNSS);
P3: gNB/eNB;
P4: terminal directly synchronized to gNB/eNB (UE directly synchronized to gNB/eNB);
P5: terminal indirectly synchronized to gNB/eNB (UE indirectly synchronized to gNB/eNB); and
P6: the remaining terminals have the lowest priority (the remaining UEs have the lowest priority).

In the synchronization method with gNB/eNB as the highest-priority synchronization source, the priority order is as follows:
P0′: gNB/eNB;
P1′: terminal directly synchronized to gNB/eNB (UE directly synchronized to gNB/eNB);
P2′: terminal indirectly synchronized to gNB/eNB (UE indirectly synchronized to gNB/eNB);
P3′: GNSS;
P4′: terminal directly synchronized to GNSS (UE directly synchronized to GNSS); P5′: terminal indirectly synchronized to GNSS (UE indirectly synchronized to GNSS); and
P6′: the remaining terminals have the lowest priority (the remaining UEs have the lowest priority).

When GNSS-based synchronization is configured or preconfigured, the use of P3, P4, and P5 can be disabled through configuration or pre-configuration, such as skipping P3, P4, and P5 during the synchronization reference selection process.

During sidelink communication, changes in some conditions may trigger synchronization source selection or reselection. Such conditions include, for example, a terminal moving to the edge of network coverage or changes in the RSRP of sidelink synchronization signals. In this case, the terminal needs to select or reselect a synchronization source, such as synchronizing to another synchronization reference terminal, where this synchronization reference terminal has one of the following relationships with the current synchronization source of the terminal:
synchronized; and
asynchronized.

The terminal needs to detect the sidelink synchronization signal (SLSS)/PSBCH from the synchronization reference terminal. For a new synchronization reference terminal on the same frequency, the process includes SLSS identification (ID), PSBCH decoding, and RSRP measurement.

TS38.133 specifies requirements for the detection time and dropping rate for a terminal under different synchronization source configurations, where the sidelink synchronization signal period (SLSS period) is 160 ms. After identification of a new synchronization reference terminal is completed, the terminal performs synchronization source switching.

During the synchronization source selection or reselection process, for different synchronization reference terminals and different synchronization source priority configurations, the terminal may selectively drop some of its transmitted or received synchronization signals and sidelink data, aiming to detect synchronization signals/channels from the synchronization reference terminal. TS38.133 specifies the maximum allowed dropping rate to ensure normal sidelink communication.

The related technologies and concepts involved in the embodiments of this application have been described above. The following details a sidelink positioning reference signal processing method in the embodiments of this application with reference to the accompanying drawings through some embodiments and application scenarios thereof.

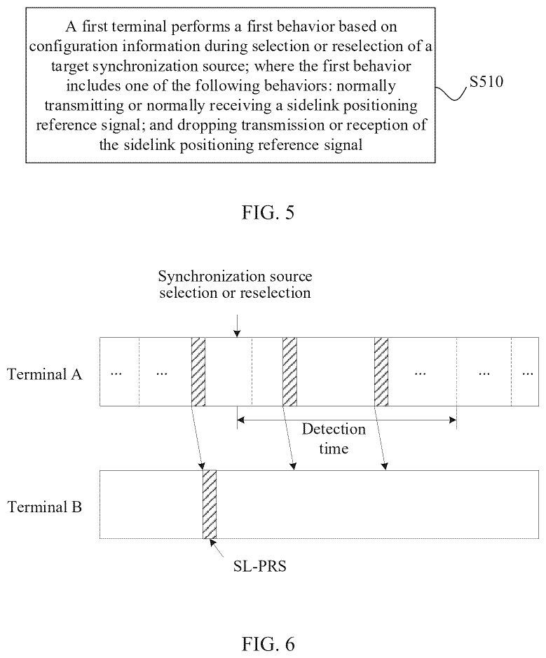

Referring to FIG. 5, a sidelink positioning reference signal processing method according to an embodiment of this application may include the following step.

S510: A first terminal performs a first behavior based on configuration information, during selection or reselection of a target synchronization source; where
the first behavior includes one of the following behaviors:
normally transmitting or normally receiving a sidelink positioning reference signal; and
dropping transmission or reception of the sidelink positioning reference signal; and
the configuration information is used to configure priorities of multiple synchronization sources.

In the embodiments of this application, the first terminal may be a terminal 11 shown in FIG. 1, or the first terminal may be a terminal 1 shown in FIG. 2.

The first terminal may obtain the configuration information, where the configuration information is used to configure priorities of multiple synchronization sources. The configuration information may be configured or preconfigured by a network-side device or specified by a protocol.

A current synchronization source of the first terminal may be one of a GNSS, an eNB/gNB (a serving cell/primary cell of the first terminal), and a synchronization reference terminal. Changes in some conditions may trigger the selection or reselection of a synchronization source. During selection or reselection of a target synchronization source by the first terminal, interruption may occur, and the terminal behavior of transmitting or receiving a sidelink positioning reference signal needs to be clarified to reduce impact on sidelink positioning.

In this case, the first terminal may perform the first behavior based on the configuration information. The first behavior may include normally transmitting or normally receiving a sidelink positioning reference signal, or dropping (drop) transmission or reception of the sidelink positioning reference signal.

Dropping transmission or reception of the sidelink positioning reference signal may be understood as not transmitting or not receiving the sidelink positioning reference signal, or may be understood as dropping sidelink data transmission/reception, where sidelink data transmission/reception includes transmission or reception of a sidelink positioning reference signal.

With the method provided in the embodiments of this application, during selection or reselection of a synchronization source by the terminal, the sidelink positioning reference signal processing behavior of the terminal is clarified, ensuring smooth sidelink positioning and improving sidelink communication efficiency.

In some embodiments of this application, in a case that the configuration information is used to configure a global navigation satellite system as a highest-priority synchronization source, and that a synchronization source of the first terminal is the global navigation satellite system, the first behavior includes normally transmitting or normally receiving a sidelink positioning reference signal.

In the embodiments of this application, the first terminal may determine, based on the configuration information, that the global navigation satellite system is the highest-priority synchronization source. If the current synchronization source of the first terminal is the global navigation satellite system, it indicates that the first terminal is directly synchronized to the global navigation satellite system. During selection or reselection of a target synchronization source, the terminal does not drop any sidelink synchronization signals or sidelink data, such as the sidelink positioning reference signal. Therefore, in this case, the first terminal normally transmits or receives the sidelink positioning reference signal, clarifying the sidelink positioning reference signal processing behavior of the first terminal.

In some embodiments of this application, in a case that the configuration information is used to indicate the global navigation satellite system as the highest-priority synchronization source, and that the target synchronization source is a first synchronization reference terminal, the performing, by a first terminal, a first behavior based on configuration information may include the following steps:
step 1: obtaining, by the first terminal, first information, where the first information is used to indicate whether a synchronization source of the first terminal is synchronized with the first synchronization reference terminal; and
step 2: performing, by the first terminal, the first behavior based on the first information and the configuration information.

For ease of description, the above two steps are described in combination.

In the embodiments of this application, the first terminal may determine, based on the configuration information, that the global navigation satellite system is the highest-priority synchronization source. When the target synchronization source selected or reselected by the first terminal is the first synchronization reference terminal, the first terminal may obtain first information, where the first information is used to indicate whether the synchronization source of the first terminal is synchronized with the first synchronization reference terminal. The synchronization source of the first terminal refers to the current synchronization source of the first terminal.

The first terminal may perform the first behavior based on the first information and the configuration information.

Optionally, in a case that the first information is used to indicate that the synchronization source of the first terminal is synchronized with the first synchronization reference terminal, the first behavior includes normally transmitting or normally receiving a sidelink positioning reference signal.

Optionally, in a case that the first information is used to indicate that the synchronization source of the first terminal is asynchronized with the first synchronization reference terminal, the first terminal is allowed to drop transmission or reception of the sidelink positioning reference signal.

For example, the current synchronization source of the first terminal is a synchronization reference terminal 1, the synchronization reference terminal 1 is directly or indirectly synchronized to GNSS, and the target synchronization source selected or reselected by the first terminal is a synchronization reference terminal 2. If the synchronization reference terminal 2 is synchronized with the synchronization reference terminal 1, a sidelink synchronization signal transmitted by the first terminal fully overlaps with a sidelink synchronization signal from the synchronization reference terminal 2. In this case, the first terminal may drop the transmission of its own sidelink synchronization signal during a time period or time window for detecting sidelink synchronization signals, but does not drop the transmission or reception of a sidelink data channel, and the first terminal normally transmits or receives a sidelink positioning reference signal. If the synchronization reference terminal 2 is asynchronized with the synchronization reference terminal 1, the first terminal is allowed to drop the transmission or reception of a signal or a channel, including dropping the transmission or reception of a sidelink positioning reference signal, during the time period or time window for detecting sidelink synchronization signals.

A length of the time period or time window for detecting sidelink synchronization signals is one sidelink synchronization signal period.

Optionally, in a case that the first information is used to indicate that the synchronization source of the first terminal is asynchronized with the first synchronization reference terminal, and that a sidelink positioning reference signal period is less than or equal to a sidelink synchronization signal period, the first behavior includes dropping transmission or reception of the sidelink positioning reference signal.

That is, in a case that the global navigation satellite system is the highest-priority synchronization source, that the target synchronization source is the first synchronization reference terminal, that the synchronization source of the first terminal is asynchronized with the first synchronization reference terminal, and that the sidelink positioning reference signal period is less than or equal to the sidelink synchronization signal period, the first terminal drops the transmission or reception of the sidelink positioning reference signal.

It can be understood that if the synchronization source of the first terminal is asynchronized with the first synchronization reference terminal, and the sidelink positioning reference signal period is less than or equal to the sidelink synchronization signal period, at least one sidelink positioning reference signal is included within the time period or time window for detecting sidelink synchronization signals. In this case, the first terminal drops the transmission or reception of the sidelink positioning reference signal during the time period or time window for detecting sidelink synchronization signals. Optionally, the first behavior performed by the first terminal may further include dropping reception of the sidelink positioning reference signal during decoding of a physical sidelink broadcast channel.

Optionally, in a case that the first information is used to indicate that the synchronization source of the first terminal is asynchronized with the first synchronization reference terminal, and that a sidelink positioning reference signal period is greater than a sidelink synchronization signal period, the first behavior includes normally transmitting or normally receiving a sidelink positioning reference signal.

That is, in a case that the global navigation satellite system is the highest-priority synchronization source, that the target synchronization source is the first synchronization reference terminal, that the synchronization source of the first terminal is asynchronized with the first synchronization reference terminal, and that the sidelink positioning reference signal period is greater than the sidelink synchronization signal period, the first terminal normally transmits or receives the sidelink positioning reference signal.

It can be understood that if the synchronization source of the first terminal is asynchronized with the first synchronization reference terminal, and the sidelink positioning reference signal period is greater than the sidelink synchronization signal period, it may be possible to avoid the transmission or reception of a sidelink positioning reference signal during the time period or time window for detecting sidelink synchronization signals. In this case, the first terminal normally transmits or receives the sidelink positioning reference signal.

Optionally, the first terminal performs detection for a sidelink synchronization signal within a first time period, where there is no transmission or reception of the sidelink positioning reference signal within the first time period. Optionally, the first terminal staggers a measurement window for detecting the sidelink synchronization signal from a measurement window corresponding to the transmission or reception of the sidelink positioning reference signal in time domain.

The embodiments of this application clarify the sidelink positioning reference signal processing behavior of the first terminal in a case that the global navigation satellite system is the highest-priority synchronization source, and that the first synchronization reference terminal selected or reselected by the first terminal is synchronized or asynchronized with the synchronization source of the first terminal.

In some embodiments of this application, in a case that the configuration information is used to configure a serving cell or a primary cell of the first terminal as a highest-priority synchronization source, that the target synchronization source is a second synchronization reference terminal, and that a synchronization source of the first terminal is asynchronized with the second synchronization reference terminal, the performing, by a first terminal, a first behavior based on configuration information includes:
step 1: obtaining, by the first terminal, second information, where the second information is used to indicate a magnitude relationship between a sidelink positioning reference signal period and a sidelink synchronization signal period; and
step 2: performing, by the first terminal, the first behavior based on the second information and the configuration information.

For ease of description, the above two steps are described in combination.

In the embodiments of this application, the first terminal may determine, based on the configuration information, that the serving cell or primary cell of the first terminal is the highest-priority synchronization source. When the target synchronization source selected or reselected by the first terminal is the second synchronization reference terminal, and the synchronization source of the first terminal is asynchronized with the second synchronization reference terminal, the first terminal may obtain second information, where the second information is used to indicate a magnitude relationship between a sidelink positioning reference signal period and a sidelink synchronization signal period.

The first terminal may perform the first behavior based on the second information and the configuration information.

Optionally, in a case that the second information is used to indicate that the sidelink positioning reference signal period is less than or equal to the sidelink synchronization signal period, the first behavior includes dropping transmission or reception of the sidelink positioning reference signal.

That is, in a case that the serving cell or primary cell of the first terminal is the highest-priority synchronization source, that the target synchronization source is the second synchronization reference terminal, that the synchronization source of the first terminal is asynchronized with the second synchronization reference terminal, and that the sidelink positioning reference signal period is less than or equal to the sidelink synchronization signal period, the first terminal drops the transmission or reception of the sidelink positioning reference signal.

It can be understood that if the synchronization source of the first terminal is asynchronized with the second synchronization reference terminal, and the sidelink positioning reference signal period is less than or equal to the sidelink synchronization signal period, at least one sidelink positioning reference signal is included within the time period or time window for detecting sidelink synchronization signals. In this case, the first terminal drops the transmission or reception of the sidelink positioning reference signal during the time period or time window for detecting sidelink synchronization signals. Optionally, the first behavior performed by the first terminal may further include dropping reception of the sidelink positioning reference signal during decoding of a physical sidelink broadcast channel.

Optionally, in a case that the second information is used to indicate that the sidelink positioning reference signal period is greater than the sidelink synchronization signal period, the first behavior includes normally transmitting or normally receiving a sidelink positioning reference signal.

That is, in a case that the serving cell or primary cell of the first terminal is the highest-priority synchronization source, that the target synchronization source is the second synchronization reference terminal, that the synchronization source of the first terminal is asynchronized with the second synchronization reference terminal, and that the sidelink positioning reference signal period is greater than the sidelink synchronization signal period, the first terminal normally transmits or receives a sidelink positioning reference signal.

It can be understood that if the synchronization source of the first terminal is asynchronized with the second synchronization reference terminal, and the sidelink positioning reference signal period is greater than the sidelink synchronization signal period, it may be possible to avoid the transmission or reception of a sidelink positioning reference signal during the time period or time window for detecting sidelink synchronization signals. In this case, the first terminal normally transmits or receives the sidelink positioning reference signal.

Optionally, the first terminal performs detection for a sidelink synchronization signal within a first time period, where there is no transmission or reception of the sidelink positioning reference signal within the first time period. Optionally, the first terminal staggers a measurement window for detecting the sidelink synchronization signal from a measurement window corresponding to the transmission or reception of the sidelink positioning reference signal in time domain.

The embodiments of this application clarify the sidelink positioning reference signal processing behavior of the first terminal in a case that the serving cell or primary cell of the first terminal is the highest-priority synchronization source, and that the second synchronization reference terminal selected or reselected by the first terminal is asynchronized with the synchronization source of the first terminal.

For ease of understanding, the following describes the embodiments of this application again through specific examples.
Example 1: As shown in FIG. 6, a terminal A and a terminal B perform sidelink communication, where the terminal A is a terminal transmitting a sidelink positioning reference signal, and the terminal B is a terminal receiving the sidelink positioning reference signal. When the terminal A performs synchronization source selection or reselection, identification of a target synchronization source needs to be completed within a detection time, and how the terminal A transmits a sidelink positioning reference signal during this detection time needs to be clarified.

### (1) GNSS as a Highest-Priority Synchronization Source:

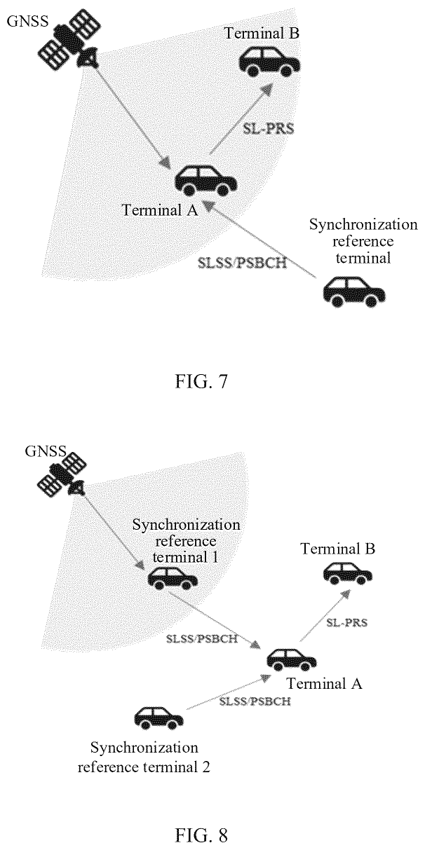

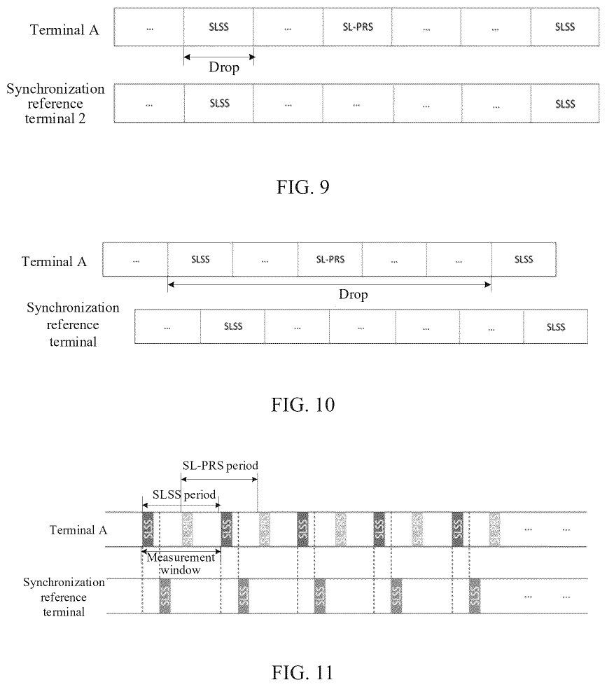

When GNSS is configured as the highest-priority synchronization source, terminal behaviors for the following cases are defined.
1. As shown in FIG. 7, the terminal A is directly synchronized to a GNSS. In any case, for example, that the target synchronization source selected or reselected by the terminal A is a synchronization reference terminal, the terminal A does not drop transmission of any SLSS or SL data (for example, an SL-PRS). In this case, the terminal A normally transmits an SL-PRS.
2. As shown in FIG. 8, the terminal A is synchronized to a synchronization reference terminal 1, the synchronization reference terminal is directly or indirectly synchronized to the GNSS, the target synchronization source selected or reselected by the terminal A is a synchronization reference terminal 2, and the synchronization reference terminal 1 is synchronized with the synchronization reference terminal 2 to be detected. In this case, an SLSS transmitted by the terminal A fully overlaps with an SLSS from the synchronization reference terminal 2 in time domain, as shown in FIG. 9. Therefore, the terminal A drops transmission of its own SLSS signal during a time window for detecting SLSS, with a length of the time window being one SLSS period, but it does not drop transmission or reception of an SL data channel, including an SL-PRS signal. In this case, the terminal A normally transmits an SL-PRS.
3. In other cases, that is, when the terminal A needs to detect an SLSS transmitted by a synchronization reference terminal that is asynchronized with the current synchronization source, the terminal A is allowed to drop signals/channels, including SL-PRS, during the entire time period/time window for detecting SLSS, for example the time period/time window corresponding to drop in FIG. 10. In the case of asynchronization, since the SLSS transmitted by the terminal A and the SLSS transmitted by the synchronization reference terminal are at different positions in time domain, the terminal A needs to detect the SLSS transmitted by the synchronization reference terminal over an entire time-domain window, and thus drops SL data within the time-domain window.

When there is dropping of SL-PRS, it is necessary to set an appropriate measurement period to still obtain valid measurement results.

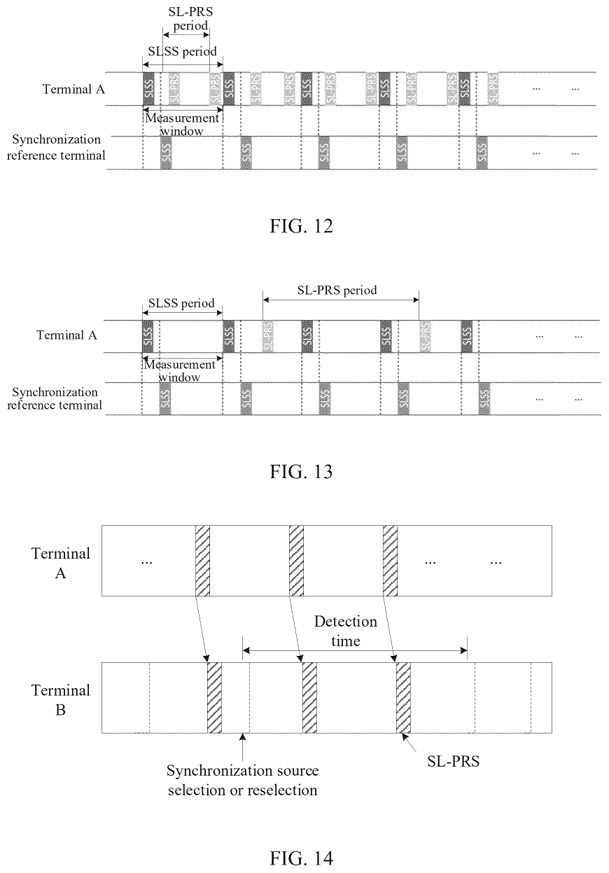

Assuming that obtaining one valid SL-PRS result requires M SL-PRS samples, the following cases exist.
a. When the SL-PRS period is less than or equal to the SLSS period, dropping SL-PRS is allowed, as shown in FIG. 11 and FIG. 12.
b. When the SL-PRS period is greater than the SLSS period, dropping SL-PRS is not allowed, as shown in FIG. 13.

In case a, at least one SL-PRS is included within one measurement window, that is, at least one SL-PRS is dropped within one measurement window, as shown in FIG. 11 and FIG. 12. In case b, it is possible to avoid dropping SL-PRS within the measurement window, as long as the terminal A staggers the measurement window for detecting SLSS from the measurement window in which SL-PRS is transmitted, meaning that the terminal A performs SLSS detection in a measurement window without SL-PRS, as shown in FIG. 13.

### (2) Serving Cell or Primary Cell of Terminal B as the Highest-Priority Synchronization Source:

The terminal behavior is consistent with that described in 3 (other cases).
Example 2: As shown in FIG. 14, the terminal A and the terminal B perform sidelink communication, where the terminal A is a terminal transmitting SL-PRS, and the terminal B is a terminal receiving SL-PRS. When the terminal B performs synchronization source selection or reselection, identification of a target synchronization source needs to be completed within a detection time, and how the terminal B receives a sidelink positioning reference signal during this detection time needs to be clarified.

If the terminal B performs synchronization source selection/reselection during the measurement, in a case that the target synchronization source is synchronized with a current synchronization source of the terminal B, SL-PRS is normally received and measured. However, in a case that the target synchronization source is asynchronized with the current synchronization source of the terminal B, during PSBCH decoding, the terminal B is allowed to drop some SL data. If the SL data dropped by the terminal includes an SL-PRS sample, a valid measurement result can be obtained by extending the measurement time, consistent with the transmission case above.

The embodiments of this application clarify the terminal behavior for transmission or reception of a sidelink positioning reference signal during selection or reselection of a synchronization source by the terminal, ensuring smooth sidelink positioning and improving sidelink communication efficiency.

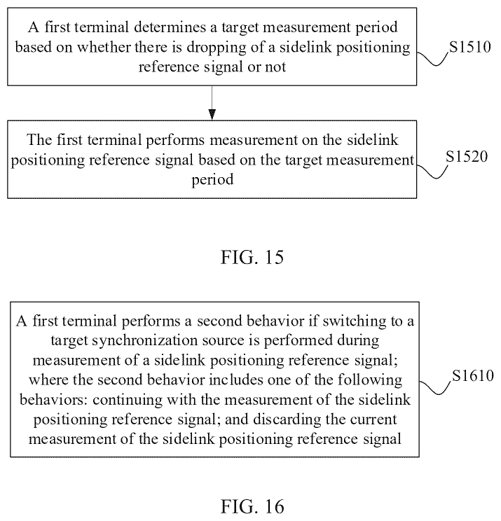

FIG. 15 is a flowchart of another sidelink positioning reference signal processing method according to an embodiment of this application. The method may include the following steps.

S1510: A first terminal determines a target measurement period based on whether there is dropping of a sidelink positioning reference signal or not.

The target measurement period is at least related to the following time:
a measurement time of a first number of sidelink positioning reference signal samples required to obtain one valid measurement result.

In the embodiments of this application, the first terminal may drop the transmission or reception of a sidelink positioning reference signal for some reasons. For example, during selection or reselection of a synchronization source, the first terminal may perform a first behavior based on configuration information that is used to configure priorities of multiple synchronization sources, where the first behavior includes one of the following behaviors: normally transmitting or normally receiving a sidelink positioning reference signal; and dropping transmission or reception of the sidelink positioning reference signal.

The first terminal may determine a target measurement period based on whether there is dropping of a sidelink positioning reference signal or not. The target measurement period is at least related to the following time: a measurement time of a first number of sidelink positioning reference signal samples required to obtain one valid measurement result. One valid measurement result is obtained by measuring the first number of sidelink positioning reference signal samples. For example, if the first number is M, after M sidelink positioning reference signal samples are measured, M measurement results are obtained, and the M measurement results are processed according to a given rule, such as averaging, to obtain one valid measurement result.

Optionally, in a case that there is no dropping of sidelink positioning reference signal, the target measurement period is at least related to the measurement time of the first number of sidelink positioning reference signal samples required to obtain one valid measurement result. For example, if the first number is M and the sidelink positioning reference signal period is TSI-PRS, the target measurement period is Tₘₑₐₛ=M*T_{SL-PRS}.

S1520: The first terminal performs measurement on the sidelink positioning reference signal based on the target measurement period.

After determining the target measurement period based on whether there is dropping of a sidelink positioning reference signal, the first terminal may perform measurement on the sidelink positioning reference signal based on the target measurement period, which facilitates acquisition of valid measurement results.

With the method provided in the embodiments of this application, the first terminal determines a target measurement period based on whether there is dropping of a sidelink positioning reference signal or not, and then performs measurement on the sidelink positioning reference signal based on the target measurement period, where the target measurement period is at least related to a measurement time of a first number of sidelink positioning reference signal samples required to obtain one valid measurement result. This clarifies the terminal measurement behavior and measurement period for sidelink positioning reference signals, facilitating acquisition of valid measurement results, ensuring smooth sidelink positioning, and improving sidelink communication efficiency.

In some embodiments of this application, in a case that there is dropping of a sidelink positioning reference signal, the target measurement period is further related to the following time:
a measurement time of a second number of additional sidelink positioning reference signal samples allowed to be obtained.

It can be understood that if there is dropping of a sidelink positioning reference signal, to obtain a valid measurement result, the terminal needs to extend the corresponding measurement time, which requires the terminal to be allowed to obtain an additional number of sidelink positioning reference signal samples.

In the embodiments of this application, in a case that there is dropping of a sidelink positioning reference signal, the target measurement period determined by the first terminal is at least related to the following times:
a measurement time of a first number of sidelink positioning reference signal samples required to obtain one valid measurement result; and
a measurement time of a second number of additional sidelink positioning reference signal samples allowed to be obtained.

After the target measurement period is determined based on the above times, measurement is performed on the sidelink positioning reference signals based on the target measurement period.

The second number is less than or equal to a first threshold, where the first threshold may be specified by a protocol or configured by a network-side device. If the second number is equal to the first threshold and a valid measurement result cannot be obtained based on the determined target measurement period, the first terminal restarts the measurement.

Assuming the first number is M and the second number is L, the determined target measurement period may be Tₘₑₐₛ=(M+L)*T_{SL-PRS}.

In a case that there is dropping of a sidelink positioning reference signal, the target measurement period is at least related to the above times, facilitating acquisition of valid measurement results.

In some embodiments of this application, in a case that sidelink discontinuous reception is enabled, the target measurement period is further related to the following time: a cycle time for a third number of sidelink discontinuous receptions required to obtain one valid measurement result.

It can be understood that to reduce power consumption, the terminal may enable sidelink discontinuous reception, and the terminal with sidelink discontinuous reception enabled receives data only during the sidelink discontinuous reception active period. Therefore, in a case that sidelink discontinuous reception is enabled, the cycle time of sidelink discontinuous reception also needs to be considered in determining the target measurement period.

In the embodiments of this application, in a case that there is no dropping of sidelink positioning reference signals but sidelink discontinuous reception is enabled, the target measurement period determined by the first terminal is at least related to the following times:
a measurement time of a first number of sidelink positioning reference signal samples required to obtain one valid measurement result; and
a cycle time for a third number of sidelink discontinuous receptions required to obtain one valid measurement result.

If the first number is M, the third number is N, and the sidelink discontinuous reception cycle time is SL-DRX cycle, the determined target measurement period may be Tₘₑₐₛ=max(M*TSI-PRS, N*SL-DRX cycle).

In a case that there is dropping of a sidelink positioning reference signal and sidelink discontinuous reception is enabled, the target measurement period determined by the first terminal is at least related to the following times:
a measurement time of a first number of sidelink positioning reference signal samples required to obtain one valid measurement result;
a measurement time of a second number of additional sidelink positioning reference signal samples allowed to be obtained; and
a cycle time for a third number of sidelink discontinuous receptions required to obtain one valid measurement result.

In a case that there is dropping of a sidelink positioning reference signal and sidelink discontinuous reception is enabled, the second number may be the number of sidelink discontinuous reception cycles, each cycle including at least one additional sidelink positioning reference signal sample allowed to be obtained. The second number is less than or equal to a second threshold, where the second threshold may be specified by a protocol or configured by a network-side device. If the second number is equal to the second threshold and a valid measurement result cannot be obtained based on the determined target measurement period, the first terminal restarts the measurement.

The third number may be specified by a protocol or configured by a network-side device, and the third number may or may not be equal to the first number.

If the first number is M, the second number is Lₘ, the third number is N, and the sidelink discontinuous reception cycle time is SL-DRX cycle, the determined target measurement period may be Tₘₑₐₛ=max((M+Lₘ)*T_{SL-PRS}, N*SL-DRX cycle).

In a case that sidelink discontinuous reception is enabled, the target measurement period is at least related to the above times, facilitating acquisition of valid measurement results.

For ease of understanding, the following describes the technical solutions provided in the embodiments of this application through specific examples.

I. Examples for the Case that there is Dropping of a Sidelink Positioning Reference Signal
Example 1: The first number is M, where M=4, and T_{SL-PRS}=1 SLSS period=160 ms:
(1) If sidelink discontinuous reception is not enabled, the target measurement period is Tₘₑₐₛ=(4+L)×160 ms.
(2) If sidelink discontinuous reception is enabled and the sidelink discontinuous reception cycle time SL-DRX cycle is less than or equal to 160 ms, the target measurement period is Tₘₑₐₛ=(4+Lₘ)×160 ms.
(3) If sidelink discontinuous reception is enabled and the sidelink discontinuous reception cycle time SL-DRX cycle is greater than 160 ms, the target measurement period is Tₘₑₐₛ=(4+Lₘ)×SL-DRX cycle.
Example 2:

$$M = 2 , and {T}_{SL - PRS} = 1 SLSS period = 160 ms :$$

(1) If sidelink discontinuous reception is not enabled, the target measurement period is Tₘₑₐₛ=(2+L)×160 ms.
(2) If sidelink discontinuous reception is enabled and the sidelink discontinuous reception cycle time SL-DRX cycle is less than or equal to 160 ms, the target measurement period is Tₘₑₐₛ=(2+Lₘ)×160 ms.
(3) If sidelink discontinuous reception is enabled and the sidelink discontinuous reception cycle time SL-DRX cycle is greater than 160 ms, the target measurement period is Tₘₑₐₛ=(2+Lₘ)×SL-DRX cycle.
Example 3:

$$M = 4 , and {T}_{SL - PRS} = 0.5 * SLSS period = 80 ms :$$

(1) If sidelink discontinuous reception is not enabled, the target measurement period is Tₘₑₐₛ=(4+L)×80 ms.
(2) If sidelink discontinuous reception is enabled and the sidelink discontinuous reception cycle time SL-DRX cycle is less than or equal to 80 ms, the target measurement period is Tₘₑₐₛ=(4+Lₘ)×80 ms.
(3) If sidelink discontinuous reception is enabled and the sidelink discontinuous reception cycle time SL-DRX cycle is greater than 80 ms, the target measurement period is Tₘₑₐₛ=(4+Lₘ)×SL-DRX cycle.
Example 4:

$$M = 2 , and {T}_{SL - PRS} = 0.5 * SLSS period = 80 ms :$$

(1) If sidelink discontinuous reception is not enabled, the target measurement period is Tₘₑₐₛ=(2+L)×80 ms.
(2) If sidelink discontinuous reception is enabled and the sidelink discontinuous reception cycle time SL-DRX cycle is less than or equal to 80 ms, the target measurement period is Tₘₑₐₛ=(2+Lₘ)×80 ms.
(3) If sidelink discontinuous reception is enabled and the sidelink discontinuous reception cycle time SL-DRX cycle is greater than 80 ms, the target measurement period is Tₘₑₐₛ=(2+Lₘ)×SL-DRX cycle.

In the above examples, if multiple sidelink discontinuous reception cycle times are configured, the SL-DRX cycle mentioned above is the smallest one.

L is the number of additional sidelink positioning reference signal samples allowed to be obtained, and L is less than or equal to Lₘₐₓ. Lₘ is the number of sidelink discontinuous reception cycles, each cycle including at least one additional sidelink positioning reference signal sample allowed to be obtained, and Lₘ is less than or equal to L_{m,max}.

II. Examples for the Case that No Sidelink Positioning Reference Signal is Dropped
Example 1:

$$M = 4 , and {T}_{SL - PRS} = 2 * SLSS period = 320 ms :$$

(1) If sidelink discontinuous reception is not enabled, the target measurement period is Tₘₑₐₛ=4×320 ms=1280 ms.
(2) If sidelink discontinuous reception is enabled and the sidelink discontinuous reception cycle time SL-DRX cycle is less than or equal to 320 ms, the target measurement period is Tₘₑₐₛ=4×320 ms=1280 ms.
(3) If sidelink discontinuous reception is enabled and the sidelink discontinuous reception cycle time SL-DRX cycle is greater than 320 ms, the target measurement period is Tₘₑₐₛ=4×SL-DRX cycle.
Example 2:

$$M = 2 , and {T}_{SL - PRS} = 2 * SLSS period = 320 ms :$$

(1) If sidelink discontinuous reception is not enabled, the target measurement period Tₘₑₐₛ=2×320 ms=640 ms.
(2) If sidelink discontinuous reception is enabled and the sidelink discontinuous reception cycle time SL-DRX cycle is less than or equal to 320 ms, the target measurement period is Tₘₑₐₛ=2×320 ms=640 ms.
(3) If sidelink discontinuous reception is enabled and the sidelink discontinuous reception cycle time SL-DRX cycle is greater than 320 ms, the target measurement period is Tₘₑₐₛ=2×SL-DRX cycle.

In the above examples, if multiple sidelink discontinuous reception cycle times are configured, the SL-DRX cycle mentioned above is the smallest one.

The embodiments of this application clarify the terminal measurement behavior and measurement period for sidelink positioning reference signals in a case that there is dropping of a sidelink positioning reference signal or there is no dropping of a sidelink positioning reference signal, facilitating acquisition of valid measurement results, ensuring smooth sidelink positioning, and improving sidelink communication efficiency.

FIG. 16 is a flowchart of another sidelink positioning reference signal processing method according to an embodiment of this application. The method may include the following step.

S1610: A first terminal performs a second behavior if switching to a target synchronization source is performed during measurement of a sidelink positioning reference signal; where
the second behavior includes one of the following behaviors:
continuing with the measurement of the sidelink positioning reference signal; and
discarding the current measurement of the sidelink positioning reference signal.

The measurement of the sidelink positioning reference signal includes at least one of the following:
sidelink positioning reference signal based receive-transmit time difference measurement;
sidelink positioning reference signal based reference signal time difference measurement;
sidelink positioning reference signal based reference signal received power measurement;
sidelink positioning reference signal based reference signal received path power measurement;
sidelink positioning reference signal based relative time of arrival measurement;
sidelink positioning reference signal based azimuth angle of arrival measurement; and
sidelink positioning reference signal based zenith angle of arrival measurement.

That is, the measurement quantity may be at least one of a sidelink positioning reference signal based receive-transmit time difference, a sidelink positioning reference signal based reference signal time difference, a sidelink positioning reference signal based reference signal received power, a sidelink positioning reference signal based reference signal received path power, a sidelink positioning reference signal based relative time of arrival, a sidelink positioning reference signal based azimuth angle of arrival, or a sidelink positioning reference signal based zenith angle of arrival.

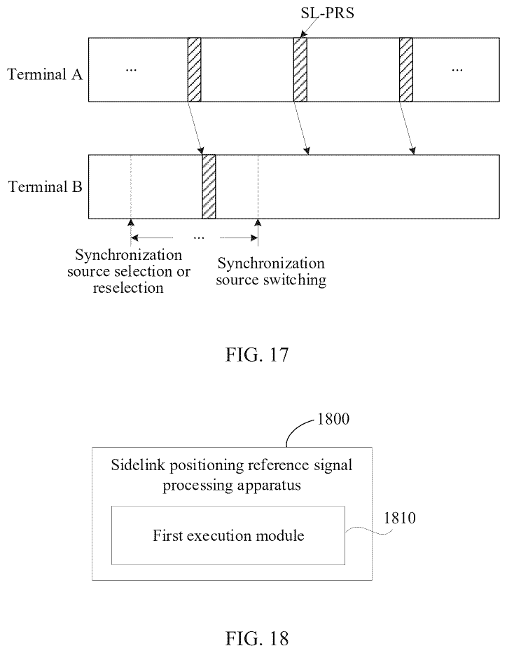

To obtain valid measurement results for the above measurement quantities, multiple sidelink positioning reference signal samples need to be measured. During the measurement of multiple sidelink positioning reference signal samples, that is, during the process of the terminal measuring the sidelink positioning reference signal, synchronization source selection or reselection may occur, or synchronization source switching may occur before all sidelink positioning reference signal samples are measured, as shown in FIG. 17. This may affect sidelink positioning measurements, such as reducing positioning accuracy or causing resource waste. Therefore, it is necessary to clarify the terminal measurement behavior in such cases.

In the embodiments of this application, the first terminal may perform a second behavior if switching to a target synchronization source is performed during measurement of a sidelink positioning reference signal, where the second behavior includes one of the following behaviors: continuing with the measurement of the sidelink positioning reference signal or discarding the current measurement of the sidelink positioning reference signal.

Optionally, in a case that the target synchronization source is synchronized with a pre-switching synchronization source of the first terminal, the second behavior includes continuing with the measurement of the sidelink positioning reference signal. That is, in a case that the target synchronization source is synchronized with the pre-switching synchronization source of the first terminal, the first terminal continues with the measurement of the sidelink positioning reference signal after switching to the target synchronization source, regardless of which measurement quantity is being measured.

Optionally, in a case that the target synchronization source is asynchronized with the pre-switching synchronization source of the first terminal, the second behavior includes discarding the current measurement of the sidelink positioning reference signal. That is, in a case that the target synchronization source is asynchronized with the pre-switching synchronization source of the first terminal, the first terminal discards the current measurement of the sidelink positioning reference signal after switching to the target synchronization source, regardless of which measurement quantity is being measured.

With the method provided in the embodiments of this application, after the terminal switches the synchronization source, the terminal measurement behavior for sidelink positioning reference signals is clarified, ensuring smooth sidelink positioning and improving sidelink communication efficiency.

The sidelink positioning reference signal processing method provided in the embodiments of this application may be executed by a sidelink positioning reference signal processing apparatus. In the embodiments of this application, the sidelink positioning reference signal processing apparatus performing the sidelink positioning reference signal processing method is used as an example to describe the sidelink positioning reference signal processing apparatus provided in the embodiments of this application.

As shown in FIG. 18, the sidelink positioning reference signal processing apparatus 1800 may include the following module:
a first execution module 1810 configured to perform a first behavior based on configuration information during selection or reselection of a target synchronization source; where
the first behavior includes one of the following behaviors:
normally transmitting or normally receiving a sidelink positioning reference signal; and
dropping transmission or reception of the sidelink positioning reference signal; and
the configuration information is used to configure priorities of multiple synchronization sources.

With the apparatus provided in the embodiment of this application, during selection or reselection of a synchronization source by the terminal, the sidelink positioning reference signal processing behavior of the terminal is clarified, ensuring smooth sidelink positioning and improving sidelink communication efficiency.

In some embodiments of this application, in a case that the configuration information is used to configure a global navigation satellite system as a highest-priority synchronization source, and that a synchronization source of the first terminal is the global navigation satellite system, the first behavior includes normally transmitting or normally receiving a sidelink positioning reference signal.

In some embodiments of this application, in a case that the configuration information is used to configure a global navigation satellite system as a highest-priority synchronization source, and that the target synchronization source is a first synchronization reference terminal, the first execution module 1810 is configured to:
obtain first information, where the first information is used to indicate whether a synchronization source of the first terminal is synchronized with the first synchronization reference terminal; and
perform the first behavior based on the first information and the configuration information.

In some embodiments of this application, in a case that the first information is used to indicate that the synchronization source of the first terminal is synchronized with the first synchronization reference terminal, the first behavior includes normally transmitting or normally receiving a sidelink positioning reference signal.

In some embodiments of this application, in a case that the first information is used to indicate that the synchronization source of the first terminal is asynchronized with the first synchronization reference terminal, and that a sidelink positioning reference signal period is less than or equal to a sidelink synchronization signal period, the first behavior includes dropping transmission or reception of the sidelink positioning reference signal.

In some embodiments of this application, in a case that the first information is used to indicate that the synchronization source of the first terminal is asynchronized with the first synchronization reference terminal, and that a sidelink positioning reference signal period is greater than a sidelink synchronization signal period, the first behavior includes normally transmitting or normally receiving a sidelink positioning reference signal.

In some embodiments of this application, in a case that the configuration information is used to configure a serving cell or a primary cell of the first terminal as a highest-priority synchronization source, that the target synchronization source is a second synchronization reference terminal, and that a synchronization source of the first terminal is asynchronized with the second synchronization reference terminal, the first execution module 1810 is configured to:
obtain second information, where the second information is used to indicate a magnitude relationship between a sidelink positioning reference signal period and a sidelink synchronization signal period; and
perform the first behavior based on the second information and the configuration information.

In some embodiments of this application, in a case that the second information is used to indicate that the sidelink positioning reference signal period is less than or equal to the sidelink synchronization signal period, the first behavior includes dropping transmission or reception of the sidelink positioning reference signal.

In some embodiments of this application, the first behavior further includes dropping reception of the sidelink positioning reference signal during decoding of a physical sidelink broadcast channel.

In some embodiments of this application, in a case that the second information is used to indicate that the sidelink positioning reference signal period is greater than the sidelink synchronization signal period, the first behavior includes normally transmitting or normally receiving a sidelink positioning reference signal.

In some embodiments of this application, the first execution module 1810 is further configured to:
perform detection for a sidelink synchronization signal within a first time period, where there is no transmission or reception of the sidelink positioning reference signal within the first time period.

The sidelink positioning reference signal processing apparatus 1800 provided in the embodiments of this application can implement the processes implemented in the method embodiments shown in FIG. 5 to FIG. 14, with the same technical effects achieved. To avoid repetition, details are not described herein again.

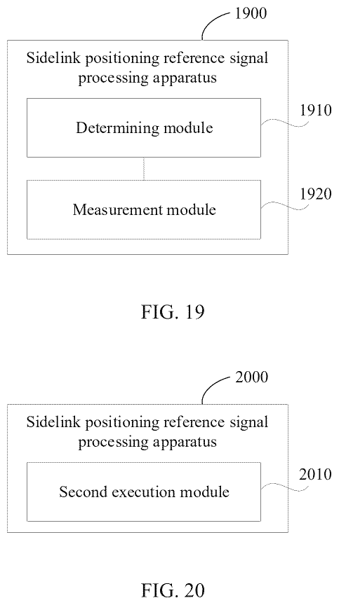

As shown in FIG. 19, a sidelink positioning reference signal processing apparatus 1900 may include the following modules:
a determining module 1910 configured to determine a target measurement period based on whether there is dropping of a sidelink positioning reference signal or not; and
a measurement module 1920 configured to perform measurement on the sidelink positioning reference signal based on the target measurement period; where the target measurement period is at least related to the following time:
a measurement time of a first number of sidelink positioning reference signal samples required to obtain one valid measurement result.

With the apparatus provided in the embodiment of this application, a target measurement period is determined based on whether there is dropping of a sidelink positioning reference signal or not, and then measurement on the sidelink positioning reference signal is performed based on the target measurement period, where the target measurement period is at least related to a measurement time of a first number of sidelink positioning reference signal samples required to obtain one valid measurement result. This clarifies the terminal measurement behavior and measurement period for sidelink positioning reference signals, facilitating acquisition of valid measurement results, ensuring smooth sidelink positioning, and improving sidelink communication efficiency.

In some embodiments of this application, in a case that there is dropping of a sidelink positioning reference signal, the target measurement period is further related to the following time:
a measurement time of a second number of additional sidelink positioning reference signal samples allowed to be obtained.

In some embodiments of this application, in a case that sidelink discontinuous reception is enabled, the target measurement period is further related to the following time:
a cycle time for a third number of sidelink discontinuous receptions required to obtain one valid measurement result.

The sidelink positioning reference signal processing apparatus 1900 provided in the embodiments of this application can implement the processes implemented in the method embodiment shown in FIG. 15, with the same technical effects achieved. To avoid repetition, details are not described herein again.

As shown in FIG. 20, a sidelink positioning reference signal processing apparatus 2000 may include the following module:
a second execution module 2010 configured to perform a second behavior if switching to a target synchronization source is performed during measurement of a sidelink positioning reference signal; where
the second behavior includes one of the following behaviors:
continuing with the measurement of the sidelink positioning reference signal; and
discarding the current measurement of the sidelink positioning reference signal.

With the apparatus provided in the embodiment of this application, after synchronization source switching is performed, the sidelink positioning reference signal measurement behavior of the terminal is clarified, ensuring smooth sidelink positioning and improving sidelink communication efficiency.

In some embodiments of this application, in a case that the target synchronization source is synchronized with a pre-switching synchronization source of the first terminal, the second behavior includes continuing with the measurement of the sidelink positioning reference signal.

In some embodiments of this application, in a case that the target synchronization source is asynchronized with a pre-switching synchronization source of the first terminal, the second behavior includes discarding the current measurement of the sidelink positioning reference signal.

In some embodiments of this application, the measurement of the sidelink positioning reference signal includes at least one of the following:
sidelink positioning reference signal based receive-transmit time difference measurement;
sidelink positioning reference signal based reference signal time difference measurement;
sidelink positioning reference signal based reference signal received power measurement;
sidelink positioning reference signal based reference signal received path power measurement;
sidelink positioning reference signal based relative time of arrival measurement;
sidelink positioning reference signal based azimuth angle of arrival measurement; and
sidelink positioning reference signal based zenith angle of arrival measurement.

The sidelink positioning reference signal processing apparatus 2000 provided in the embodiments of this application can implement the processes implemented in the method embodiments shown in FIG. 16 and FIG. 17, with the same technical effects achieved. To avoid repetition, details are not described herein again.

An embodiment of this application further provides a terminal including a processor and a communication interface, where the communication interface is coupled to the processor, and the processor is configured to execute a program or instructions to implement the steps of the method embodiments shown in FIG. 5 to FIG. 17. The terminal embodiment corresponds to the foregoing terminal-side method embodiments, and all implementation processes and implementations of the foregoing method embodiments are applicable to the terminal embodiment, with the same technical effects achieved.

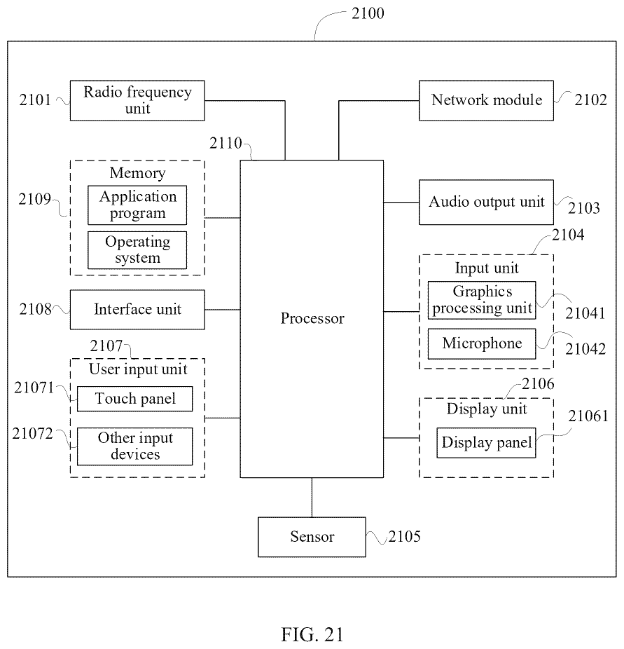

Specifically, FIG. 21 is a schematic structural diagram of a terminal implementing an embodiment of this application. The terminal 2100 includes, but is not limited to, at least some of the following components: a radio frequency unit 2101, a network module 2102, an audio output unit 2103, an input unit 2104, a sensor 2105, a display unit 2106, a user input unit 2107, an interface unit 2108, a memory 2109, a processor 2110, and the like.

Those skilled in the art can understand that the terminal 2100 may further include a power source (such as a battery) that supplies power to each component. The power source may be logically connected to the processor 2110 through a power management system, thereby implementing functions such as charging, discharging, and power consumption management through the power management system. The terminal structure shown in FIG. 21 does not constitute a limitation on the terminal, and the terminal may include more or fewer components than shown, or combine certain components, or have a different component arrangement, which is not described herein again.

It should be understood that in the embodiments of this application, the input unit 2104 may include a graphics processing unit (GPU) 21041 and a microphone 21042. The graphics processing unit 21041 processes image data of still pictures or videos obtained by an image capture device (such as a camera) in a video capture mode or an image capture mode. The display unit 2106 may include a display panel 21061, which may be configured in the form of a liquid crystal display, an organic light-emitting diode, or the like. The user input unit 2107 includes at least one of a touch panel 21071 and other input devices 21072. The touch panel 21071 is also referred to as a touchscreen. The touch panel 21071 may include two parts: a touch detection device and a touch controller. The other input devices 21072 may include, but are not limited to, a physical keyboard, a function key (such as a volume control key or an on/off key), a trackball, a mouse, and a joystick, which are not described herein.

In the embodiments of this application, after receiving downlink data from a network-side device, the radio frequency unit 2101 may transmit it to the processor 2110 for processing; additionally, the radio frequency unit 2101 may send uplink data to the network-side device. Typically, the radio frequency unit 2101 includes, but is not limited to, an antenna, an amplifier, a transceiver, a coupler, a low noise amplifier, a duplexer, and the like.

The memory 2109 may be configured to store software programs or instructions and various data. The memory 2109 may primarily include a first storage area for storing programs or instructions and a second storage area for storing data, where the first storage area may store an operating system, an application or instruction required for at least one function (such as a sound play function or an image play function), and the like. Further, the memory 2109 may include a volatile memory or a non-volatile memory. The non-volatile memory may be a read-only memory (ROM), a programmable ROM (PROM), an erasable PROM (EPROM), an electrically erasable PROM (Electrically EPROM, EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), or a direct Rambus RAM DRRAM). The memory 2109 in the embodiments of this application includes, but is not limited to, these and any other suitable types of memory.

The processor 2110 may include one or more processing units. Optionally, an application processor and a modem processor are integrated in the processor 2110, where the application processor primarily handles operations related to the operating system, user interface, and applications, and the modem processor, such as a baseband processor, primarily handles wireless communication signals. It can be understood that the modem processor may alternatively be not integrated into the processor 2110.

The processor 2110 is configured to perform a first behavior based on configuration information during selection or reselection of a target synchronization source; where
the first behavior includes one of the following behaviors:
normally transmitting or normally receiving a sidelink positioning reference signal; and
dropping transmission or reception of the sidelink positioning reference signal; and
the configuration information is used to configure priorities of multiple synchronization sources.

Alternatively, the processor 2110 is configured to determine a target measurement period based on whether there is dropping of a sidelink positioning reference signal or not; and
perform measurement on the sidelink positioning reference signal based on the target measurement period; where
the target measurement period is at least related to the following time:
a measurement time of a first number of sidelink positioning reference signal samples required to obtain one valid measurement result.

Alternatively, the processor 2110 is configured to perform a second behavior if switching to a target synchronization source is performed during measurement of a sidelink positioning reference signal; where
the second behavior includes one of the following behaviors:
continuing with the measurement of the sidelink positioning reference signal; and
discarding the current measurement of the sidelink positioning reference signal.

It can be understood that for the implementation processes of the implementations mentioned in this embodiment, reference can be made to the relevant descriptions of the method embodiments, with the same or corresponding technical effects achieved. To avoid repetition, details are not described herein again.

An embodiment of this application further provides a readable storage medium. The readable storage medium stores a program or instructions, and when the program or instructions are executed by a processor, the processes of the foregoing method embodiments are implemented, with the same technical effects achieved. To avoid repetition, details are not described herein again.

The processor is the processor in the terminal described in the above embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface, where the communication interface is coupled to the processor, and the processor is configured to run a program or instructions to implement the processes of the foregoing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and the computer program/program product is executed by at least one processor to implement the processes of the foregoing method embodiments, with the same technical effects achieved. To avoid repetition, details are not described herein again.

An embodiment of this application further provides a communication system including: a first terminal and a second terminal performing sidelink communication with the first terminal, where the first terminal may be configured to perform the steps of the foregoing method embodiments.

In embodiments of this application, during selection or reselection of a synchronization source by a terminal, or after switching of a synchronization source, a sidelink positioning reference signal processing behavior of the terminal is clarified, ensuring smooth sidelink positioning and improving sidelink communication efficiency.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. The software product is stored in a storage medium (such as a ROM, a RAM, a magnetic disk, or an optical disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Those of ordinary skill in the art, under the inspiration of this application, can make many forms of implementations without departing from the principles of this application and the protection scope of the claims, and all these implementations fall within the protection scope of this application.

What is claimed is:

1. A sidelink positioning reference signal processing method, comprising:
performing, by a first terminal, a first behavior based on configuration information during selection or reselection of a target synchronization source; wherein
the first behavior comprises one of the following behaviors:
normally transmitting or normally receiving a sidelink positioning reference signal; and
dropping transmission or reception of the sidelink positioning reference signal; and
the configuration information is used to configure priorities of multiple synchronization sources.

2. The method according to claim 1, wherein in a case that the configuration information is used to configure a global navigation satellite system as a highest-priority synchronization source, and that a synchronization source of the first terminal is the global navigation satellite system, the first behavior comprises normally transmitting or normally receiving a sidelink positioning reference signal.

3. The method according to claim 1, wherein in a case that the configuration information is used to configure a global navigation satellite system as a highest-priority synchronization source, and that the target synchronization source is a first synchronization reference terminal, the performing, by a first terminal, a first behavior based on configuration information comprises:
obtaining, by the first terminal, first information, wherein the first information is used to indicate whether a synchronization source of the first terminal is synchronized with the first synchronization reference terminal; and
performing, by the first terminal, the first behavior based on the first information and the configuration information.

4. The method according to claim 3, wherein in a case that the first information is used to indicate that the synchronization source of the first terminal is synchronized with the first synchronization reference terminal, the first behavior comprises normally transmitting or normally receiving a sidelink positioning reference signal.

5. The method according to claim 3, wherein in a case that the first information is used to indicate that the synchronization source of the first terminal is asynchronized with the first synchronization reference terminal, and that a sidelink positioning reference signal period is less than or equal to a sidelink synchronization signal period, the first behavior comprises dropping transmission or reception of the sidelink positioning reference signal.

6. The method according to claim 5, wherein the first behavior further comprises dropping reception of the sidelink positioning reference signal during decoding of a physical sidelink broadcast channel.

7. The method according to claim 3, wherein in a case that the first information is used to indicate that the synchronization source of the first terminal is asynchronized with the first synchronization reference terminal, and that a sidelink positioning reference signal period is greater than a sidelink synchronization signal period, the first behavior comprises normally transmitting or normally receiving a sidelink positioning reference signal.

8. The method according to claim 7, wherein the method further comprises:
performing, by the first terminal, detection for a sidelink synchronization signal within a first time period, wherein there is no transmission or reception of the sidelink positioning reference signal within the first time period.

9. The method according to claim 1, wherein in a case that the configuration information is used to configure a serving cell or a primary cell of the first terminal as a highest-priority synchronization source, that the target synchronization source is a second synchronization reference terminal, and that a synchronization source of the first terminal is asynchronized with the second synchronization reference terminal, the performing, by a first terminal, a first behavior based on configuration information comprises:
obtaining, by the first terminal, second information, wherein the second information is used to indicate a magnitude relationship between a sidelink positioning reference signal period and a sidelink synchronization signal period; and
performing, by the first terminal, the first behavior based on the second information and the configuration information.

10. The method according to claim 9, wherein in a case that the second information is used to indicate that the sidelink positioning reference signal period is less than or equal to the sidelink synchronization signal period, the first behavior comprises dropping transmission or reception of the sidelink positioning reference signal.

11. The method according to claim 9, wherein in a case that the second information is used to indicate that the sidelink positioning reference signal period is greater than the sidelink synchronization signal period, the first behavior comprises normally transmitting or normally receiving a sidelink positioning reference signal.

12. A terminal, comprising a processor and a memory, wherein the memory stores a program or instructions capable of running on the processor, and when the program or instructions are executed by the processor, the steps of the sidelink positioning reference signal processing method according to claim 1 are implemented.

13. A sidelink positioning reference signal processing method, comprising:
determining, by a first terminal, a target measurement period based on whether there is dropping of a sidelink positioning reference signal or not; and
performing, by the first terminal, measurement on the sidelink positioning reference signal based on the target measurement period; wherein
the target measurement period is at least related to the following time:
a measurement time of a first number of sidelink positioning reference signal samples required to obtain one valid measurement result.

14. The method according to claim 13, wherein in a case that there is dropping of a sidelink positioning reference signal, the target measurement period is further related to the following time:
a measurement time of a second number of additional sidelink positioning reference signal samples allowed to be obtained.

15. The method according to claim 13, wherein in a case that sidelink discontinuous reception is enabled, the target measurement period is further related to the following time:
a cycle time for a third number of sidelink discontinuous receptions required to obtain one valid measurement result.

16. A terminal, comprising a processor and a memory, wherein the memory stores a program or instructions capable of running on the processor, and when the program or instructions are executed by the processor, the steps of the sidelink positioning reference signal processing method according to claim 13 are implemented.

17. A sidelink positioning reference signal processing method, comprising:
performing, by a first terminal, a second behavior if switching to a target synchronization source is performed during measurement of a sidelink positioning reference signal; wherein
the second behavior comprises one of the following behaviors:
continuing with the measurement of the sidelink positioning reference signal; and
discarding the current measurement of the sidelink positioning reference signal.

18. The method according to claim 17, wherein in a case that the target synchronization source is synchronized with a pre-switching synchronization source of the first terminal, the second behavior comprises continuing with the measurement of the sidelink positioning reference signal,
or
wherein in a case that the target synchronization source is asynchronized with a pre-switching synchronization source of the first terminal, the second behavior comprises discarding the current measurement of the sidelink positioning reference signal.

19. The method according to claim 17, wherein the measurement of the sidelink positioning reference signal comprises at least one of the following:
sidelink positioning reference signal based receive-transmit time difference measurement;
sidelink positioning reference signal based reference signal time difference measurement;
sidelink positioning reference signal based reference signal received power measurement;
sidelink positioning reference signal based reference signal received path power measurement;
sidelink positioning reference signal based relative time of arrival measurement;
sidelink positioning reference signal based azimuth angle of arrival measurement; and
sidelink positioning reference signal based zenith angle of arrival measurement.

20. A terminal, comprising a processor and a memory, wherein the memory stores a program or instructions capable of running on the processor, and when the program or instructions are executed by the processor, the steps of the sidelink positioning reference signal processing method according to claim 17 are implemented.
